(19) United States
(12) Patent Application Publication
(10) Pub. No.: US 2025/0147472 A1
(43) Pub. Date: May 8, 2025

(54) ELECTRONIC DEVICE FOR PERFORMING OCCUPANCY-BASED HOME ENERGY MANAGEMENT AND OPERATING METHOD THEREOF

(71) Applicant: Electronics and Telecommunications Research Institute, Daejeon (KR)

(72) Inventors: SANGKEUM LEE, Daejeon (KR); Yoonmee DOH, Daejeon (KR); Chung-ho LEE, Daejeon (KR); Tae-Wook HEO, Sejong-si (KR)

(73) Assignee: Electronics and Telecommunications Research Institute, Daejeon (KR)

(21) Appl. No.: 18/934,621

(22) Filed: Nov. 1, 2024

(30) Foreign Application Priority Data
Nov. 3, 2023 (KR) 10-2023-0150848
Mar. 20, 2024 (KR) 10-2024-0038591

(51) Int. Cl. G05B 13/02; G06N 3/044; G06N 3/0455; G06N 3/0464; G06N 3/088

(52) U.S. Cl. CPC G05B 13/027; G06N 3/044; G06N 3/0455; G06N 3/0464; G06N 3/088

(57) ABSTRACT

This invention relates to an electronic device and method for performing real-time occupancy-based home energy management. By using advanced neural network models to detect user occupancy patterns, the system optimizes appliance operation schedules to reduce energy costs, enhance system efficiency, and prolong device lifespan. The electronic device includes at least one processor and at least one memory configured to store instructions executable by the at least one processor, wherein, when at least a portion of the instructions stored in the at least one memory is executed by the at least one processor, the at least a portion of the instructions to be executed controls the electronic device to perform operations of collecting sensing data related to usage patterns of home appliances placed in an indoor area, obtaining output data by inputting the collected sensing data as input data to a neural network model for determining whether a user occupies the indoor area, and training an occupancy detection model using a reconstruction error determined through the input data and the output data.

### CROSS-REFERENCE TO RELATED APPLICATION

This application claims the benefit of Korean Patent Application No. 10-2023-0150848 filed on Nov. 3, 2023, and Korean Patent Application No. 10-2024-0038591 filed on Mar. 20, 2024, in the Korean Intellectual Property Office, the entire disclosures of which are incorporated by reference herein for all purposes.

### BACKGROUND

### 1. Field of the Invention

One or more embodiments relate to an electronic device for performing occupancy-based home energy management and an operating method thereof.

### 2. Description of the Related Art

Innovations in information and communication technology, coupled with the evolution of smart cities, have led to an increase in the use of related devices and facilities. This shift is significantly transforming the paradigms of energy management in power networks and buildings. More particularly, a conventional occupancy-based energy management systems often rely on pre-defined schedules or static occupancy patterns, limiting their adaptability to real-time conditions. Our system overcomes these limitations by dynamically adjusting energy usage in real-time based on precise occupancy detection, leading to improved energy efficiency, reduced operational costs, and increased device longevity. That is, occupancy detection is particularly valuable for improving building energy management performance and, when integrated with home data occupancy detection technologies, may lead to substantial cost savings. Recent research has focused on applying clustering algorithms and the like to home data within the context of occupancy detection. Energy profiling, such as occupancy detection, is technology in the energy market that has been constantly advancing together with crucial factors such as load prediction, pricing, demand management, and building energy demand changes.

The above information may be presented as the related art to help with the understanding of the disclosure. No arguments or decisions are raised to whether any of the above description is applicable as the prior art related to the present disclosure.

### SUMMARY

Embodiments provide a method and a device for determining whether a user occupies an indoor area using sensing data related to usage patterns of home appliances.

Embodiments provide a method and a device for scheduling operation modes of home appliances placed in an indoor area based on whether a user occupies an indoor area.

However, technical aspects are not limited to the foregoing aspects, and there may be other technical aspects.

According to an aspect, there is provided an electronic device including at least one processor and at least one memory configured to store instructions executable by the at least one processor, wherein, when at least a portion of the instructions stored in the at least one memory is executed by the at least one processor, the at least a portion of the instructions to be executed controls the electronic device to perform operations of collecting sensing data related to usage patterns of home appliances placed in an indoor area, obtaining output data by inputting the collected sensing data as input data to a neural network model for determining whether a user occupies the indoor area, and training an occupancy detection model using a reconstruction error determined through the input data and the output data.

The collecting of the sensing data may include eliminating noise by applying a discrete wavelet transform algorithm to the sensing data and performing data normalization through standardization on the sensing data from which the noise is eliminated.

The occupancy detection model may be implemented using an autoencoder in which an encoder and a decoder are combined.

The autoencoder, utilizing an unsupervised learning-based Graph Convolutional Network (GCN) and Gated Recurrent Unit (GRU) architecture, may process sensing data to detect occupancy patterns and optimize energy management.

The training of the occupancy detection model may include training the occupancy detection model such that the reconstruction error defined as a squared error is minimized.

According to another aspect, there is provided an electronic device including at least one processor and at least one memory configured to store instructions executable by the at least one processor, wherein, when at least a portion of the instructions stored in the at least one memory is executed by the at least one processor, the at least a portion of the instructions to be executed controls the electronic device to perform operations of collecting sensing data related to usage patterns of home appliances placed in an indoor area, determining whether a user occupies the indoor area by applying the collected sensing data to an occupancy detection model, and scheduling operation modes of the home appliances placed in the indoor area based on a determination of whether the user occupies the indoor area.

The occupancy detection model may be a result of training aimed at minimizing a reconstruction error determined by input data and output data, wherein the input data is the collected sensing data and the output data is obtained in response to inputting the input data to the occupancy detection model.

The determining of whether the user occupies the indoor area may include obtaining output data in response to inputting the collected sensing data as input data to the occupancy detection model, determining a reconstruction error through the input data and the output data, and deducing whether the user occupies the indoor area by comparing the determined reconstruction error with a preset occupancy detection criterion.

The scheduling of the operation modes of the home appliances may include scheduling the operation modes of the home appliances, based on a grid power consumption for a load demand of the home appliances at a predetermined time, a switch function for the grid power consumption at the predetermined time, power consumption from renewable electricity generation for the load demand of the home appliances at the predetermined time, and a switch function for power consumption from renewable electricity generation at the predetermined time, such that a profit of a renewable energy supplier is maximized.

The scheduling of the operation modes of the home appliances may include scheduling the operation modes of the home appliances, based on power consumption for a home appliance available to be scheduled at a predetermined time, a switch function for the home appliance available to be scheduled at the predetermined time, power consumption for a home appliance unavailable to be scheduled at the predetermined time, and a switch function for the home appliance unavailable to be scheduled at the predetermined time, such that a peak load is minimized.

The collecting of the sensing data may include eliminating noise by applying a discrete wavelet transform algorithm to the sensing data and performing data normalization through standardization on the sensing data from which the noise is eliminated.

The occupancy detection model may be implemented using an autoencoder in which an encoder and a decoder are combined.

The autoencoder may be configured to use an unsupervised learning-based graph convolutional network (GCN)-gated recurrent unit (GRU) network.

According to another aspect, there is provided an operating method of an electronic device, the operating method including collecting sensing data related to usage patterns of home appliances placed in an indoor area, determining whether a user occupies the indoor area by applying the collected sensing data to an occupancy detection model, and scheduling operation modes of the home appliances, considering real-time occupancy data and optimizing for energy efficiency and cost savings by adjusting operations based on user presence within the indoor area.

The occupancy detection model may be a result of training aimed at minimizing a reconstruction error determined by input data and output data, wherein the input data is the collected sensing data and the output data is obtained in response to inputting the input data to the occupancy detection model.

The determining of whether the user occupies the indoor area may include obtaining output data in response to inputting the collected sensing data as input data to the occupancy detection model, determining a reconstruction error through the input data and the output data, and deducing whether the user occupies the indoor area by comparing the determined reconstruction error with a preset occupancy detection criterion.

The scheduling of the operation modes of the home appliances may include scheduling the operation modes of the home appliances, based on a grid power consumption for a load demand of the home appliances at a predetermined time, a switch function for the grid power consumption at the predetermined time, power consumption from renewable electricity generation for the load demand of the home appliances at the predetermined time, and a switch function for the power consumption from renewable electricity generation at the predetermined time, such that a profit of a renewable energy supplier is maximized.

The scheduling of the operation modes of the home appliances may include scheduling the operation modes of the home appliances, based on power consumption for a home appliance available to be scheduled at a predetermined time, a switch function for the home appliance available to be scheduled at the predetermined time, power consumption for a home appliance unavailable to be scheduled at the predetermined time, and a switch function for the home appliance unavailable to be scheduled at the predetermined time, such that a peak load is minimized.

The occupancy detection model may be implemented using an autoencoder in which an encoder and a decoder are combined.

The autoencoder may be configured to use an unsupervised learning-based GCN-GRU network.

Additional aspects of embodiments will be set forth in part in the description which follows and, in part, will be apparent from the description, or may be learned by practice of the disclosure.

According to an embodiment, it may be possible to determine whether a user occupies an indoor area using sensing data related to usage patterns of home appliances placed in the indoor area.

According to an embodiment, it may be possible to minimize a peak load and reduce electricity rates by scheduling operation modes of home appliances placed in an indoor area based on whether a user occupies the indoor area.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of an electronic device according to an embodiment;

FIG. 2 is a diagram illustrating an overall configuration of a smart home according to an embodiment;

FIG. 3 is a flowchart illustrating specific operations of an electronic device for training and evaluating an occupancy detection model, according to an embodiment;

FIG. 4 is a flowchart illustrating specific operations of an electronic device for scheduling operation modes of home appliances using an occupancy detection model, according to an embodiment; and

FIG. 5 is a diagram illustrating the structure of an occupancy detection model according to an embodiment.

### DETAILED DESCRIPTION

The following detailed structural or functional description is provided as an example only and various alterations and modifications may be made to embodiments. Accordingly, the embodiments are not to be construed as limited to the disclosure and should be understood to include all changes, equivalents, or replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” include the plural forms as well, unless the context clearly indicates otherwise. As used herein, each of phrases such as “A or B,” “at least one of A and B,” “at least one of A or B,” “A, B, or C,” “at least one of A, B, and C,” and “at least one of A, B, or C” may include any one of the items listed in the corresponding one of the phrases or all possible combinations thereof. It will be further understood that the terms “comprises/comprising” and/or “includes/including,” when used herein, specify the presence of stated features, integers, steps, operations, elements, components, or groups thereof but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

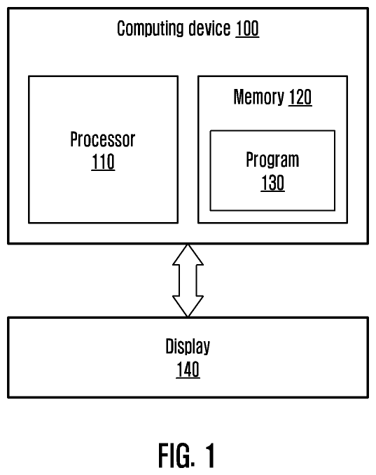

FIG. 1 is a diagram illustrating a configuration of an electronic device according to an embodiment.

As illustrated in FIG. 1, an electronic device 100 may include at least one processor 110 and a memory 120 that loads or stores a program 130 executed by the processor 110. The components included in the electronic device 100 of FIG. 1 are only examples, and one of ordinary skill in the art may understand that other generally used components may be further included besides the components illustrated in FIG. 1.

The processor 110 may manage the overall operation of the electronic device, including collecting, processing, and analyzing sensing data. It may execute the instructions stored in memory 120 to perform occupancy detection by applying the collected data to a neural network model, and subsequently schedule appliance operations based on the real-time occupancy status of the indoor area. The processor 110 may include at least one of a central processing unit (CPU), a microprocessor unit (MPU), a microcontroller unit (MCU), a graphics processing unit (GPU), a neural processing unit (NPU), a digital signal processor (DSP), and other well-known types of processors in a relevant field of technology. In addition, the processor 110 may perform an operation of at least one application or program to perform the methods/operations described herein according to embodiments. The electronic device 100 may include at least one processor.

The memory 120 may store one of, or a combination of two or more of, various pieces of data, commands, and pieces of information that are used by the components (e.g., the processor 110) included in the electronic device 100. The memory 120 may include a volatile memory and/or a non-volatile memory.

The program 130 may include one or more actions through which the methods/operations described herein according to embodiments are implemented and may be stored in the memory 120 as software. In this case, an action may correspond to a command that is implemented in the program 130. For example, the program 130 may include instructions to perform an operation of collecting sensing data related to usage patterns of home appliances placed in an indoor area, an operation of obtaining output data in response to inputting the collected sensing data as input data to an occupancy detection model for determining whether a user occupies the indoor area, and an operation of training the occupancy detection model using a reconstruction error determined through the input data and the output data.

When the program 130 is loaded in the memory 120, the processor 110 may execute a plurality of operations to implement the program 130 and perform the methods/operations described herein according to embodiments.

An execution screen of the program 130 may be displayed on a display 140. Although the display 140 is illustrated as being a separate device connected to the electronic device 100 in FIG. 1, the display 140 may be included in the components of the electronic device 100 when the electronic device 100 is a smartphone, a tablet, or other terminals that are portable by a user. The screen displayed on the display 140 may be a state before information is input to the program 130 or may be an execution result of the program 130.

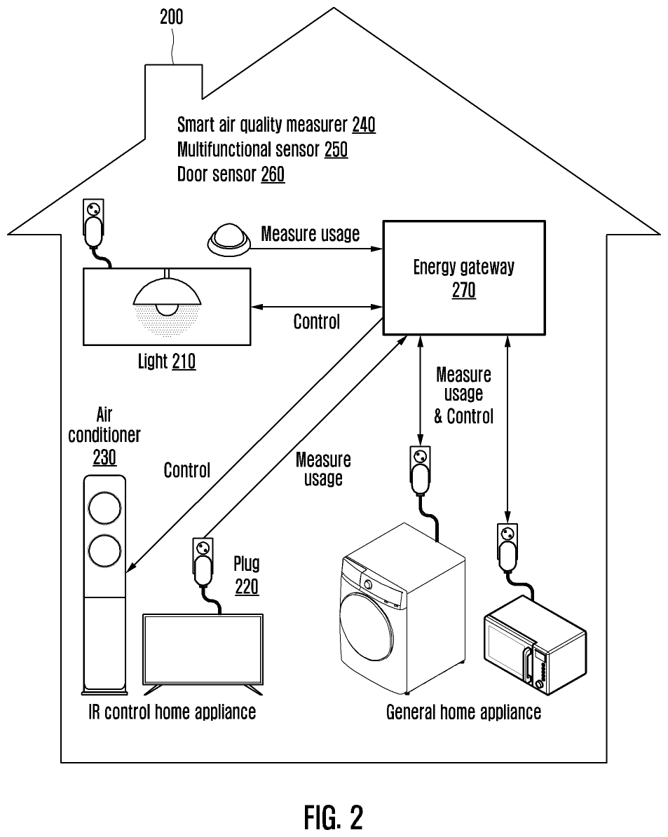

FIG. 2 is a diagram illustrating an overall configuration of a smart home according to an embodiment.

The smart home provided in the present disclosure may determine whether a user occupies an indoor area, thereby reducing electricity rates through a power-saving function for a power-saving home appliance and achieving efficient energy saving through deep learning-based clustering. Referring to FIG. 2, a smart home 200 may include a plurality of sensors and schedule operation modes of home appliances for efficient energy saving by analyzing sensing data collected through the plurality of sensors.

The time an occupant spends on a general occupancy behavior may be greater in the order of sleeping, going out, working, resting, cooking, eating, exercising, dishwashing, using a hairdryer, cleaning, and walking. In this case, the top seven (sleeping, going out, working, resting, cooking, eating, and exercising) occupancy behaviors may account for 98% or more of the time spent among all occupancy behaviors. For example, the temperature, humidity, and CO₂ of a living room may be highly correlated with exercising among occupancy behaviors, and the temperature, humidity, CO₂, and kitchen PM25 may be highly correlated with cooking. Therefore, detecting the same occupancy information through sensing data of various home appliances placed in the smart home 200 may be significantly helpful for energy saving.

For example, in the smart home 200, at least one sensor may be disposed in home appliances such as a smart light switch 210, a smart plug 220, a smart air conditioner controller 230, a smart air quality measurer 240, a multifunctional sensor 250, and a door sensor 260. However, the types of home appliances in which sensors are disposed are only examples and not limited to the examples described above.

The smart home 200 may further include an energy gateway 270. The energy gateway 270 may collect sensing data related to usage patterns of home appliances from at least one sensor disposed in the home appliances. The energy gateway 270 may determine whether a user occupies an indoor area by analyzing the sensing data related to the collected usage patterns of the home appliances.

The energy gateway 270 may schedule optimized operation modes of home appliances for energy saving, based on the determination of whether the user occupies the indoor area, and build an efficient and robust smart building system by automatically controlling the operation modes of the home appliances included in the smart home 200 according to the scheduled operation modes.

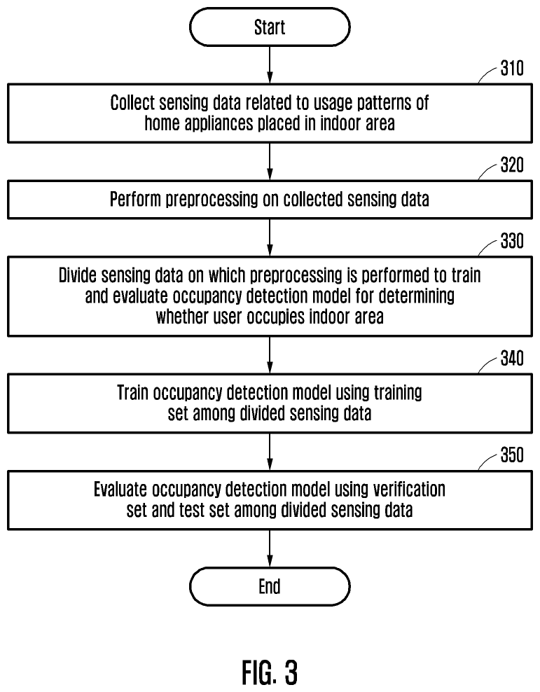

FIG. 3 is a flowchart illustrating specific operations of an electronic device for training and evaluating an occupancy detection model, according to an embodiment. In an embodiment, at least one of the operations of FIG. 3 may be simultaneously or in parallel performed with one another, and the order of the operations may be changed. In addition, at least one of the operations may be omitted or another operation may be additionally performed. The operations of FIG. 3 may be performed by at least one component of an electronic device (e.g., the electronic device 100 of FIG. 1). For example, the electronic device may correspond to the energy gateway of FIG. 2.

In operation 310, the electronic device may collect sensing data related to usage patterns of home appliances placed in an indoor area. For example, the electronic device may collect sensing data related to usage patterns of various types of home appliances such as a light, heating and cooling, and an electronic device.

In operation 320, the electronic device may perform preprocessing on the collected sensing data. First, the electronic device may perform data organizing and sampling on the collected sensing data. More particularly, the electronic device may classify and organize the collected sensing data into household data by household and assign tag values. In this case, the electronic device may perform resampling at a predetermined interval (e.g., a 15-minute interval).

The electronic device may eliminate noise from the sensing data on which data organizing and sampling are performed. More particularly, the electronic device may eliminate noise by applying a discrete wavelet transform algorithm to the sensing data on which data organizing and sampling are performed. The electronic device may terminate preprocessing by performing normalization through standardization on the sensing data from which noise is eliminated, and thus, the preprocessed sensing data may have reduced complexity.

In operation 330, the electronic device may divide the sensing data on which preprocessing is performed to train and evaluate an occupancy detection model for determining whether a user occupies an indoor area. More particularly, the electronic device may divide the sensing data on which preprocessing is performed into a training set, a verification set, and a test set.

In operation 340, the electronic device may train the occupancy detection model using the training set among the divided sensing data. The occupancy detection model may be implemented using an autoencoder in which an encoder and a decoder are combined. In this case, the autoencoder may use unsupervised learning that predicts a result for new data by clustering prediction data without a ground truth label.

For example, the autoencoder may be implemented using an unsupervised learning-based graph convolutional network (GCN)-gated recurrent unit (GRU) network. However, the type of network included in the autoencoder is only an example, and embodiments are not limited thereto.

More particularly, the electronic device may obtain output data in response to inputting the training set as input data to the occupancy detection model. The electronic device may determine a reconstruction error through the obtained output data and the input data and update a parameter of the occupancy detection model such that the determined reconstruction error is minimized.

In operation 350, the electronic device may evaluate the occupancy detection model using the verification set and the test set among the divided sensing data. More particularly, the electronic device may evaluate prediction performance and classification performance of the occupancy detection model by applying the verification set and the test set to the occupancy detection model. For example, the prediction performance and the classification performance of the occupancy detection model may each be evaluated through a mean square error (MSE) and a confusion matrix. However, the method of evaluating the prediction performance and the classification performance of the occupancy detection model is only an example, and embodiments are not limited thereto.

The electronic device may determine whether the user occupies the indoor area through the occupancy detection model on which training and evaluation is performed and perform efficient energy saving by scheduling operation modes of home appliances placed in the indoor area based on the determination of whether the user occupies the indoor area. The occupancy detection model may be implemented through the autoencoder using the unsupervised learning-based GCN-GRU network. The occupancy detection model may utilize the GCN-GRU network to process the sensing data and process the sensing data sequentially input to an input layer. Then, the occupancy detection model may regenerate an input sequence of the sensing data input to the input layer through a decoder or output prediction for a target sequence.

The input data may be configured in the form of sensing data. A discrete wavelet transform algorithm may be applied to the input data in the form of sensing data to eliminate noise from the input data, and the input data may be normalized through standardization. Then, the input data in the form of refined sensing data may be input to the occupancy detection model and utilized to determine whether the user occupies the indoor area.

The output data may be a result reconstructed based on the input data or prediction for the target sequence. The occupancy detection model may calculate the reconstruction error using the input data and the output data and may be trained such that the calculated reconstruction error is minimized. Therefore, there is a correlation related to the reconstruction error between the input data and the output data, and accordingly, the performance of the occupancy detection model may be evaluated and the determination of whether the user occupies the indoor area may be performed.

The occupancy detection model configured in this way may provide functions for effectively processing the sensing data and rapidly determining whether the user occupies the indoor area.

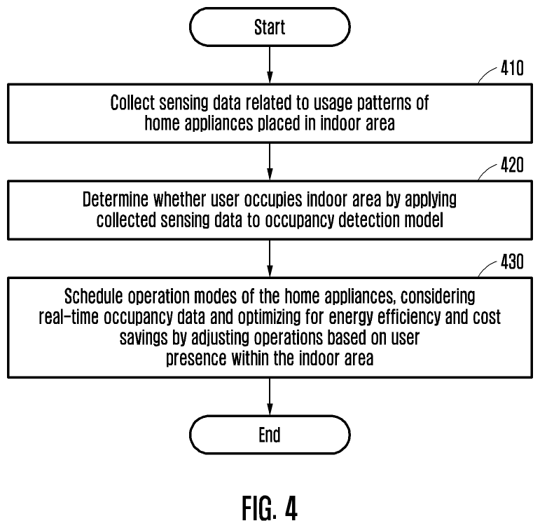

FIG. 4 is a flowchart illustrating specific operations of an electronic device for scheduling operation modes of home appliances using an occupancy detection model, according to an embodiment. In an embodiment, at least one of operations of FIG. 4 may be performed simultaneously or in parallel with another operation, and the order of the operations may be changed. In addition, at least one of the operations may be omitted or another operation may be additionally performed. The operations of FIG. 4 may be performed by at least one component of the electronic device (e.g., the electronic device 100 of FIG. 1). For example, the electronic device may correspond to the gateway of FIG. 2.

In operation 410, the electronic device may collect sensing data related to usage patterns of home appliances placed in an indoor area. For example, the electronic device may collect sensing data related to usage patterns of various types of home appliances such as a light, heating and cooling, and an electronic device.

In operation 420, the electronic device may determine whether a user occupies the indoor area by applying the collected sensing data to the occupancy detection model. In this case, the occupancy detection model may be a training result aimed at minimizing a reconstruction error, defined as the squared difference between the input data and the output data generated by the neural network model, during occupancy detection, wherein the input data is the collected sensing data and the output data is obtained in response to inputting the input data to the occupancy detection model.

In operation 430, the electronic device may schedule the operation modes of the home appliances placed in the indoor area based on the determination of whether the user occupies the indoor area. More particularly, the electronic device may utilize a first objective function of an optimization model, as expressed by Equation 1 below, to perform efficient power management of a smart home.

$$min [ {P}_{g} ( t ) * {O}_{g} ( t ) - {P}_{P} ( t ) * {O}_{P} ( t ) ] \qquad [ Equation 1 ]$$

Here, P_{g}(t) may denote a grid power consumption for a load demand at a time t, O_{g}(t) may denote a switch function for the grid power consumption at the time t, Pₚ(t) may denote power consumption from solar power generation for the load demand, Oₚ(t) may denote a switch function for power consumption from solar power generation at the time t, and a switch function such as O_{g}(t) and Oₚ(t) may be controlled by the first objective function of the supply side.

The first objective function may suggest reducing system dependency, increasing renewable energy utilization, and maximizing the profits of a renewable energy supplier. Power management implemented by the first objective function for maximizing the profits of a renewable energy supplier may be advantageous for profit realization and may configure a profitable platform through an energy gateway. Furthermore, such power management may provide consumers with more benefits and opportunities to actively participate in the energy market.

The renewable energy supplier may act as an intermediary between the wholesale power market and consumers in the energy market. The profits of the renewable energy supplier may be calculated from energy sales revenue and the cost of purchasing energy in the wholesale market or the cost of providing services. A cost function of the renewable energy supplier may be used to estimate an optimal retail price and encourage consumers to adopt particular power consumption habits.

In addition, the electronic device may utilize a second objective function of the optimization model, as expressed by Equation 2 below, to perform efficient power management of the smart home.

$$min [ {\sum }_{i = 1}^{I} {P}_{s , i} ( t ) * {O}_{s , i} ( t ) + {\sum }_{i = 1}^{J} {P}_{n s , j} ( t ) * {O}_{n s , j} ( t ) - {P}_{P} ( t ) * {O}_{P} ( t ) ] * D ( t ) \qquad [ Equation 2 ]$$

Here, P_{s,i}(t) may denote power consumption for a home appliance available to be scheduled as the ith at the time t, O_{s,i}(t) may denote a switch function for the home appliance available to be scheduled as the ith, P_{ns,j}(t) may denote power consumption for a home appliance unavailable to be scheduled as jth at the time t, O_{ns,j}(t) may denote a switch function for the home appliance unavailable to be scheduled as jth, and D(t) may denote a time-based demand response (DR) program at the time t.

The second objective function may suggest minimizing a peak load while considering electricity rates using the DR program. Because the energy gateway has a low load capacity, the maintenance costs of the entire energy management system may increase within a few hours at the maximum load. Therefore, reducing the maximum load by a few hours may lower the maintenance costs of the entire energy management system and build a more robust design of the energy management system.

The electronic device may schedule a movable load according to power management using the second objective function. However, the electronic device may not schedule a non-interruptible load according to power management and supply power to the load immediately when needed.

In this case, the electronic device may perform power management for the smart home by determining whether the user occupies the indoor area according to Equation 3 below.

$${O}_{s , i} ( t ) = \{ \begin{matrix}1 ( presence ) & {e}_{t} \leq θ \\ 0 ( absense ) & {e}_{t} \leq θ\end{matrix} \qquad [ Equation 3 ]$$

Here, et may denote the reconstruction error determined through an autoencoder using the GCN-GRU network and may be expressed as shown in Equation 4 below. Additionally, θ may be a preset criterion for determining occupancy. In this case, the optimal value of e for occupancy detection may be determined using an optimization algorithm to find the value that maximizes the performance of the occupancy detection model. For example, the optimal θ value for occupancy detection could be determined through grid search or cross-validation.

$${e}_{t} = {‖ {x}_{t} - {\hat{x}}_{t} ‖}^{2} \qquad [ Equation 4 ]$$

Here, xₜ and \hat{x}ₜ may denote vectors of input elements from sensing data related to usage patterns of home appliances placed in the indoor area. In other words, when it is detected that the user occupies the indoor area in the process of collecting the sensing data related to the usage patterns of the home appliances placed in the indoor area, the electronic device may replace O_{s,i}(t) with 1, and when it is detected that the user is absent, may replace O_{s,i}(t) with 0, thereby enabling more efficient power management of the smart home.

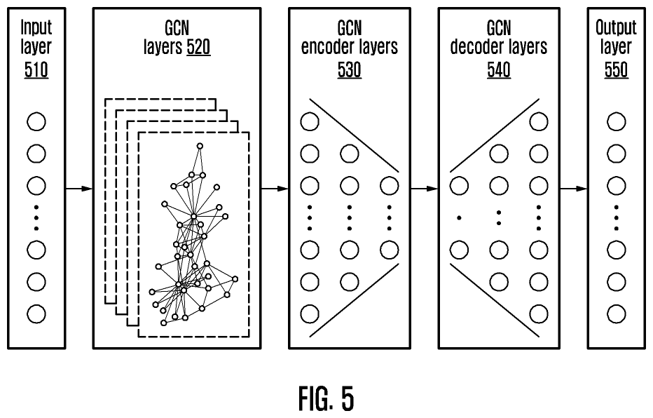

FIG. 5 is a diagram illustrating the structure of an occupancy detection model according to an embodiment.

An occupancy detection model provided in the present disclosure may be implemented through an autoencoder using an unsupervised learning-based GCN-GRU network. More particularly, referring to FIG. 5, the occupancy detection model may be implemented through the autoencoder in which an encoder 530 and a decoder 540 are combined, and the GCN (e.g., 520)-GRU (e.g., 530 and 540) network may be used to process sensing data collected from each household.

More particularly, the collected sensing data may be sequentially input as an input sequence to an input layer 510. After the last input sequence is input, the decoder 540 may regenerate an input sequence to an output layer 550 or output a prediction for a target sequence.

The autoencoder of the occupancy detection model may calculate a reconstruction error by comparing an input sequence input to the input layer 510 to an output sequence output to the output layer 550 and may be trained such that the calculated reconstruction error is minimized.

The components described in the embodiments may be implemented by hardware components including, for example, at least one DSP, a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For the purpose of simplicity, the description of a processing device is used as singular; however, one skilled in the art will appreciate that a processing device may include multiple processing elements and/or multiple types of processing elements. For example, the processing unit may include a plurality of processors, or a single processor and a single controller. In addition, different processing configurations are possible, such as parallel processors.

The software may include a computer program, a piece of code, an instruction, or one or more combinations thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. An electronic device comprising:
at least one processor; and
at least one memory configured to store instructions executable by the at least one processor,
wherein, when at least a portion of the instructions stored in the at least one memory is executed by the at least one processor, the at least a portion of the instructions to be executed controls the electronic device to perform operations of:
collecting sensing data related to usage patterns of home appliances placed in an indoor area;
obtaining output data by inputting the collected sensing data as input data to a neural network model for determining whether a user occupies the indoor area; and
training an occupancy detection model using a reconstruction error determined through the input data and the output data.

2. The electronic device of claim 1, wherein the collecting of the sensing data comprises:
eliminating noise by applying a discrete wavelet transform algorithm to the sensing data; and
performing data normalization through standardization on the sensing data from which the noise is eliminated.

3. The electronic device of claim 1, wherein the occupancy detection model is implemented using an autoencoder in which an encoder and a decoder are combined.

4. The electronic device of claim 3, wherein the autoencoder, utilizing an unsupervised learning-based Graph Convolutional Network (GCN) and Gated Recurrent Unit (GRU) architecture, processes sensing data to detect occupancy patterns and optimize energy management.

5. The electronic device of claim 1, wherein the training of the occupancy detection model comprises training the occupancy detection model such that the reconstruction error defined as a squared error is minimized.

6. An electronic device comprising:
at least one processor; and
at least one memory configured to store instructions executable by the at least one processor,
wherein, when at least a portion of the instructions stored in the at least one memory is executed by the at least one processor, the at least a portion of the instructions to be executed controls the electronic device to perform operations of:
collecting sensing data related to usage patterns of home appliances placed in an indoor area;
determining whether a user occupies the indoor area by applying the collected sensing data to an occupancy detection model; and
scheduling operation modes of the home appliances placed in the indoor area based on a determination of whether the user occupies the indoor area.

7. The electronic device of claim 6, wherein the occupancy detection model is a result of training aimed at minimizing a reconstruction error determined by input data and output data, wherein the input data is the collected sensing data and the output data is obtained in response to inputting the input data to the occupancy detection model.

8. The electronic device of claim 6, wherein the determining of whether the user occupies the indoor area comprises:
obtaining output data in response to inputting the collected sensing data as input data to the occupancy detection model;
determining a reconstruction error through the input data and the output data; and
deducing whether the user occupies the indoor area by comparing the determined reconstruction error with a preset occupancy detection criterion.

9. The electronic device of claim 6, wherein the scheduling of the operation modes of the home appliances comprises scheduling the operation modes of the home appliances, based on a grid power consumption for a load demand of the home appliances at a predetermined time, a switch function for the grid power consumption at the predetermined time, power consumption from renewable electricity generation for the load demand of the home appliances at the predetermined time, and a switch function for power consumption from renewable electricity generation at the predetermined time, such that a profit of a renewable energy supplier is maximized.

10. The electronic device of claim 6, wherein the scheduling of the operation modes of the home appliances comprises scheduling the operation modes of the home appliances, based on power consumption for a home appliance available to be scheduled at a predetermined time, a switch function for the home appliance available to be scheduled at the predetermined time, power consumption for a home appliance unavailable to be scheduled at the predetermined time, and a switch function for the home appliance unavailable to be scheduled at the predetermined time, such that a peak load is minimized.

11. The electronic device of claim 6, wherein the collecting of the sensing data comprises:
eliminating noise by applying a discrete wavelet transform algorithm to the sensing data; and
performing data normalization through standardization on the sensing data from which the noise is eliminated.

12. The electronic device of claim 6, wherein the occupancy detection model is implemented using an autoencoder in which an encoder and a decoder are combined.

13. The electronic device of claim 12, wherein the autoencoder is configured to use an unsupervised learning-based graph convolutional network (GCN)-gated recurrent unit (GRU) network.

14. An operating method of an electronic device, the operating method comprising:
collecting sensing data related to usage patterns of home appliances placed in an indoor area;
determining whether a user occupies the indoor area by applying the collected sensing data to an occupancy detection model; and
scheduling operation modes of the home appliances, considering real-time occupancy data and optimizing for energy efficiency and cost savings by adjusting operations based on user presence within the indoor area.

15. The operating method of claim 14, wherein the occupancy detection model is a result of training aimed at minimizing a reconstruction error determined by input data and output data, wherein the input data is the collected sensing data and the output data is obtained in response to inputting the input data to the occupancy detection model.

16. The operating method of claim 14, wherein the determining of whether the user occupies the indoor area comprises:
obtaining output data in response to inputting the collected sensing data as input data to the occupancy detection model;
determining a reconstruction error through the input data and the output data; and
deducing whether the user occupies the indoor area by comparing the determined reconstruction error with a preset occupancy detection criterion.

17. The operating method of claim 14, wherein the scheduling of the operation modes of the home appliances comprises scheduling the operation modes of the home appliances, based on a grid power consumption for a load demand of the home appliances at a predetermined time, a switch function for the grid power consumption at the predetermined time, power consumption from renewable electricity generation for the load demand of the home appliances at the predetermined time, and a switch function for the power consumption from renewable electricity generation at the predetermined time, such that a profit of a renewable energy supplier is maximized.

18. The operating method of claim 14, wherein the scheduling of the operation modes of the home appliances comprises scheduling the operation modes of the home appliances, based on power consumption for a home appliance available to be scheduled at a predetermined time, a switch function for the home appliance available to be scheduled at the predetermined time, power consumption for a home appliance unavailable to be scheduled at the predetermined time, and a switch function for the home appliance unavailable to be scheduled at the predetermined time, such that a peak load is minimized.

19. The operating method of claim 14, wherein the occupancy detection model is implemented using an autoencoder in which an encoder and a decoder are combined.

20. The operating method of claim 19, wherein the autoencoder is configured to use an unsupervised learning-based graph convolutional network (GCN)-grated recurrent unit (GRU) network.
